(19) United States
(12) Patent Application Publication
(10) Pub. No.: US 2013/0097388 A1
(43) Pub. Date: Apr. 18, 2013

(54) DEVICE AND DATA PROCESSING SYSTEM

(71) Applicant: Elpida Memory, Inc., Tokyo (JP)

(72) Inventor: Kazuhiko KAJIGAYA, Tokyo (JP)

(73) Assignee: Elpida Memory, Inc., Tokyo (JP)

(21) Appl. No.: 13/653,743

(22) Filed: Oct. 17, 2012

(30) Foreign Application Priority Data
Oct. 18, 2011 (JP) 2011-228980

(51) Int. Cl. G06F 12/00

(52) U.S. Cl. 711/147; 711/E12.001

(57) ABSTRACT

A device is disclosed which includes a register storing a plurality of latency data and a control unit responding to the latency data. Each of the latency data indicates a period of time between issue of a data transfer request command responsive to an access request from one of access request sources and initiation of a data transfer operation responsive to the data transfer request command. The control unit controls an order in issue of data transfer request commands responsive to access requests from the access request sources so that between issue of a first data transfer request command responsive to a first access request and initiation of a first data transfer operation responsive to the first data transfer request command, at least issue of a second data transfer request command responsive to a second access request is performed.

### BACKGROUND OF THE INVENTION

1. Field of the Invention

The present invention relates to a data processing system comprising a memory system having a plurality of memory bank groups each storing data and a control system controlling access requests to the memory system from a plurality of processing engines and processing corresponding data.

2. Description of Related Art

A configuration of a data processing system has been conventionally known in which a control device that controls data transfer of a bus master processing data is coupled via a bus to a memory device such as DRAM that stores data, and the data is transmitted between the bus master and the memory device. For example, Patent Reference 1 discloses a bus system provided with a system LSI that controls data transfer of a plurality of bus masters, and a memory having a plurality of memory banks. The bus system of Patent Reference 1 has a configuration capable of improving access efficiency by appropriately controlling an order of bus access when the bus master accesses the memory, and capable of controlling an access request of each bus master in consideration of its priority order so as to avoid occupation of a memory bus by changing the priority order. Further, Patent Reference 2 discloses a configuration in which priority order information of data transfer and its storage destination address are associated with each other and stored in a main memory, and data having the highest priority order is selectively outputted.
[Patent Reference 1] Japanese Patent Application Laid-open No. 2009-205313
[Patent Reference 2] Japanese Patent Application Laid-open No. 2008-276638 (U.S. Pat. No. 8,145,853)

In the above conventional system, it is assumed that access requests of a plurality of bus masters are successively received. For example, in the bus system of Patent Reference 1, a case is assumed in which immediately after a read operation from a memory bank including memory cells is started by an access request from a first bus master having a low priority order, an access request from a second bus master having a higher priority order than the first bus master is received. However, the bus system of Patent Reference 1 is not capable of individually setting a latency of data transfer for each memory bank, and thus there is a possibility that a read operation of the second bus master having the higher priority order might be kept waiting until the read operation of the first bus master having the lower priority order completes. Further, the bus system of Patent Reference 1 is not capable of individually setting a burst length of data transfer for each memory bank, and thus it is difficult to improve bus efficiency of the bus system as a whole when an access from a bus master that handles data of large size (large burst data bit size) in one access is started. Furthermore, Patent Reference 2 also does not disclose a configuration for individually setting the latency or the burst length for each memory bank, which clearly has the same problem as the Patent Reference 1.

### SUMMARY

A device according to an embodiment of the disclosure comprises: a register storing a plurality of latency data that correspond to a plurality of access request sources, respectively, each of the latency data including a period of time between issue of a data transfer request command responsive to an access request from an associated one of the access request sources and initiation of a data transfer operation responsive to the data transfer request command; and a control unit configured to respond to the latency data stored in the register and control an order in issue of data transfer request commands responsive respectively to access requests from the access request sources so that between issue of a first data transfer request command responsive to a first access request from a first one of the access request sources and initiation of a first data transfer operation responsive to the first data transfer request command, at least issue of a second data transfer request command responsive to a second access request from a second one of the access request sources is performed.

A data processing system according to an embodiment of the disclosure comprises: a memory system comprising a plurality of memory bank groups each including a plurality of memory banks storing data; a control system comprising a plurality of processing engines processing the data and a memory controller controlling an access to the memory system from the processing engines, the plurality of processing engines corresponding to the plurality of memory bank groups to be accessed; data lines transmitting the data between the memory system and the memory controller; and a first register storing access data including a plurality of latencies each as a time interval from issuing a command for each of the memory bank groups to staring a data transfer through the data lines, the first register being included in the memory controller, wherein each of values of the plurality of latencies is corresponded to a priority order of an access of each of the processing engines, and the memory controller controls an order of issuing commands for at least two of the memory bank groups in response to access requests from the processing engines based on the access data including the plurality of latencies.

### BRIEF DESCRIPTION OF THE DRAWINGS

FIG. 1 is a block diagram schematically showing a configuration example of a data processing system of an embodiment;

FIG. 2 is a block diagram showing a configuration of an external memory controller of FIG. 1;

FIG. 3 is a block diagram showing an entire configuration of DRAM of FIG. 1;

FIG. 4 is a diagram showing a configuration example of memory bank groups in the DRAM of FIG. 3;

FIG. 5 is a diagram showing a specific example of access patterns of bus masters and setting values of a CL/BL register corresponding to the access patterns;

FIG. 6 is a diagram explaining a setting method of a mode register of the DRAM;

FIGS. 7A and 7B are diagrams showing a specific example of data structure of an address field and set values in the CL/BL setting register in case of setting a CAS latency and a burst length in the mode register of the DRAM; and

FIG. 8 is a diagram showing a specific example of an access pattern when the DRAM is accessed by a system LSI.

### DETAILED DESCRIPTION OF THE PREFERRED EMBODIMENTS

In the following, embodiments of the present invention will be described in detail.

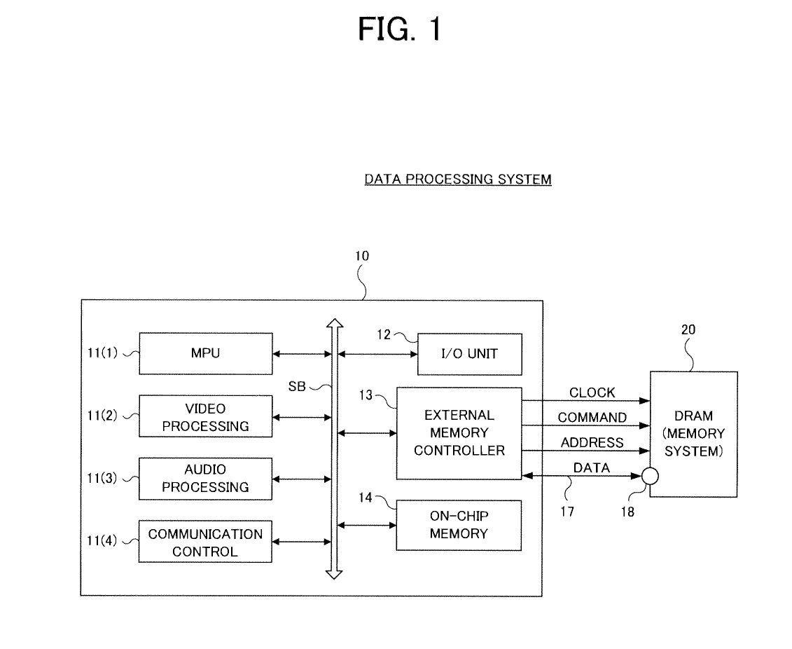

FIG. 1 is a block diagram schematically showing a configuration example of a data processing system of an embodiment. The data processing system of FIG. 1 comprises a system LSI 10 as a control system controlling operations of the data processing system as a whole, and a DRAM 20 as a memory system storing data used in the data processing system. The system LSI 10 includes four processing engines (or access request sources) 11, an I/O unit 12, an external memory controller (or control unit) 13 and an on-chip memory 14, and there is provided a system bus SB for transmitting data between these elements in the system LSI 10. Further, a clock, a command, an address and data can be respectively transmitted between the external memory controller 13 and the DRAM 20 through respective bus lines. Hereinafter, each bus line may be referred to simply as “bus”. The clock, the command and the address are transmitted from the external memory controller 13 toward the DRAM 20, while the data is transmitted bidirectionally between the external memory controller 13 and the DRAM 20.

In the example of FIG. 1, there are implemented an MPU 11(1), a video processing engine 11(2), an audio processing engine 11(3) and a communication control engine 11(4) that serve as the four processing engines 11. Each of the processing engines 11 functions as a bus master when accessing the DRAM 20. In the system LSI 10, the video processing engine 11(2) processes video data and the audio processing engine 11(3) processes audio data under the control of the MPU 11(1), and the respective data are transmitted externally by the communication control engine 11(4) , so that the system LSI 10 functions as a multi-media LSI. Further, the I/O unit 12 controls I/O operations of the system LSI 10, and the on-chip memory 14 mainly stores date that is necessary to control the MPU 11(1).

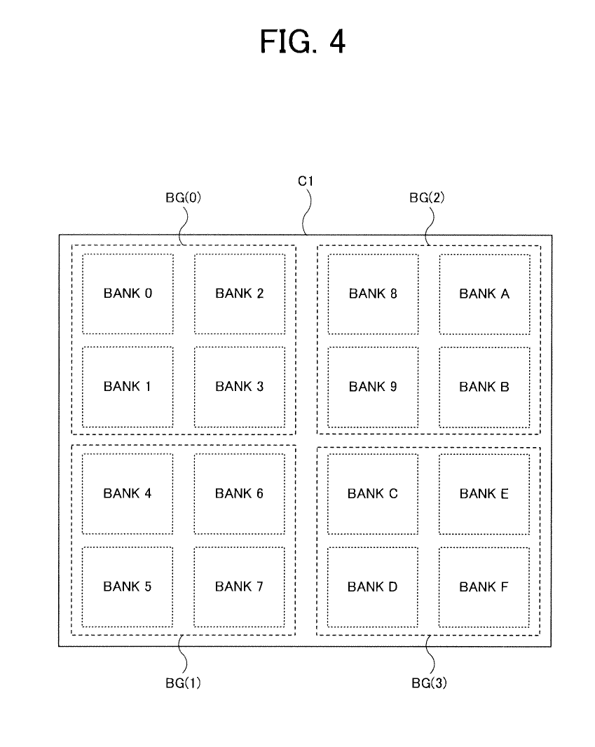

Although FIG. 1 shows the example in which the control system is configured by one system LSI 10, the control system is not limited to this configuration and may be configured by a plurality of chips. For example, the system LSI 10 may include only the I/O unit 12, the external memory controller 13 and the on-chip memory 14, and the respective processing engines 11 may be implemented in different chips, thereby entirely functioning as the control system. Further, although FIG. 1 shows the example in which the memory system is configured using one DRAM chip C1 (see FIG. 4) as the DRAM 20, the memory system may be configured using a plurality of DRAM chips without being limited to the one DRAM chip. In this case, a memory bank group may be provided in each of the DRAM chips, or the memory bank group may be provided in different chips. Furthermore, the system LSI 10 may include the memory system 20.

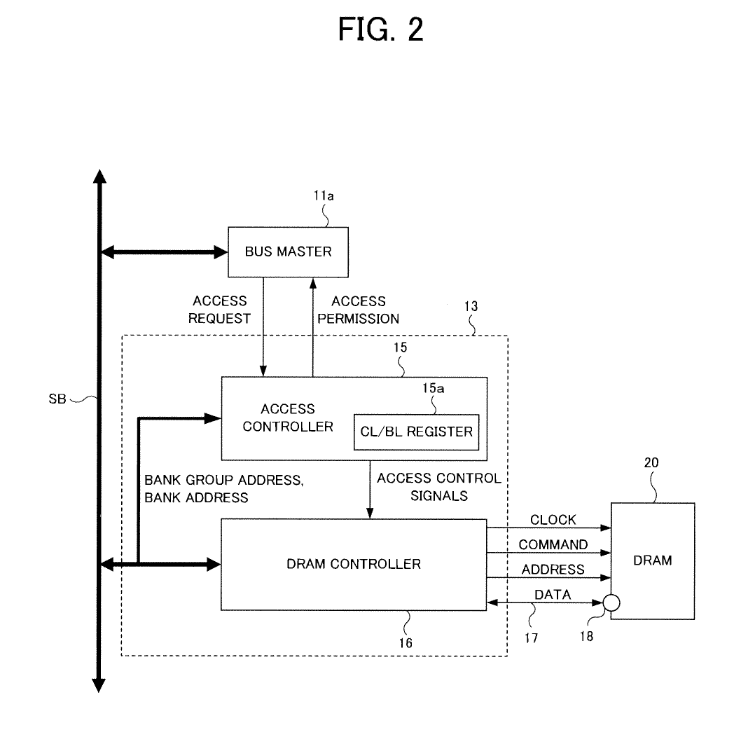

FIG. 2 is a block diagram showing a configuration of the external memory controller 13 of FIG. 1. As shown in FIG. 2, the external memory controller 13 includes an access controller 15 and a DRAM controller 16. The access controller 15 arbitrates access requests to the DRAM 20 from bus masters 11a as the processing engines 11, and sends access permission to each bus master 11a according to arbitration policy. A bus right to use the bus lines between the system bus SB and the DRAM 20 is given to a bus master 11a that has received the access permission. In other words, the access controller 15 arbitrates the access requests from the processing engines 11(1) to 11(4) based on access data (a plurality of latency data and a plurality of burst length data) stored in the first register (15a).

The access controller 15 includes a CL/BL register 15a (register) for setting CAS latencies CL and burst lengths BL for the DRAM 20. As described later, the DRAM 20 of the embodiment includes four memory bank groups each composed of four memory banks (16 memory banks in total) , and therefore access data including four CAS latencies CL and four burst lengths BL corresponding to the four memory bank groups is individually set in the CL/BL register 15a. In addition, the memory banks are memory regions that are in a relation of non-exclusive control with one another. That is, for example, two memory banks can become into an active state respectively in response to corresponding access requests from outside. The MPU 11(1) determines a memory bank group to be accessed, and determines a CAS latency CL and a burst length BL that are optimal for an access pattern of the access, for each bus master 11a, and sets them in the CL/BL register 15a first. Subsequently, the access controller 15 sets values of the CAS latency CL and the burst length BL for each memory bank group of the DRAM 20 to be controlled, and these values are set in a mode register of the DARM 20 as described later. This process is appropriately performed in states such as cold start of the system, hardware reset, software reset, and power down. The access controller 15 calculates whether or not “overtaking” is possible every time when receiving a request having a priority order from the bus master 11a, and outputs the access permission. Then, the access controller 15 sends the CAS latency CL, the burst length BL, and a memory bank group address to be accessed that correspond to bus master 11a to which the above access permission is sent, which are sent as access control signals to the DRAM controller 16.

The DRAM controller 16 performs a control in accordance with a specification for accessing the DRAM 20 in response to the access request from the bus master lla. The DRAM controller 16 refers to the access control signals received from the access controller 15 and the memory bank address received through the system bus SB. Thereby, the DRAM controller 16 sends the clock, the command and the address that are necessary to control the DRAM 20, and sends and receives the data to/from the DRAM 20 through the bus lines. When the access request from the bus master 11a is a write operation (writing data into the DRAM 20), write data of the bus master 11a is sent to the DRAM 20 after a predetermined latency is elapsed. Further, when the access request from the bus master 11a is a read operation (reading data from the DRAM 20), read data is received from the DRAM 20 and transferred to the bus master 11a after a predetermined latency is elapsed.

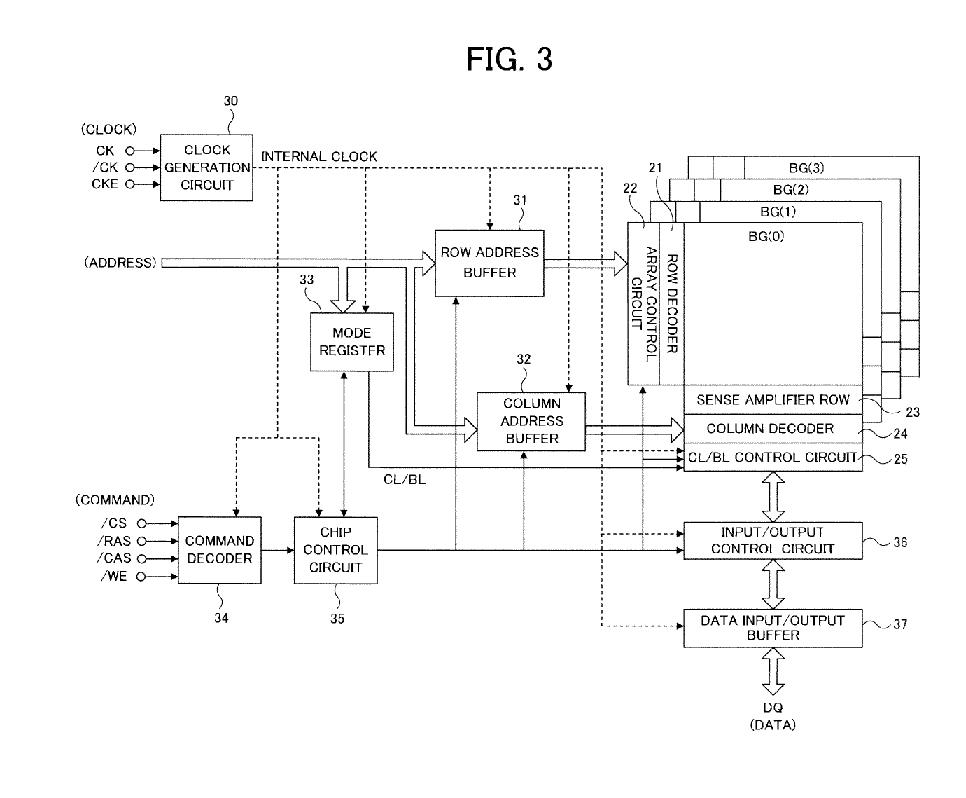

FIG. 3 is a block diagram showing an entire configuration of the DRAM 20 of FIG. 1. For example, Double Data Rate (DDR) type DRAM 20 that transfers data in synchronization with both rising and falling edges of an external clock is assumed in the embodiment. As shown in FIG. 3, the DRAM 20 includes four memory bank groups BG (represented as memory bank groups BG(0) to BG(3)) each as a memory region. Further, row circuits attached to each memory bank group BG include a row decoder 21 and an array control circuit 22, and column circuits attached to each memory bank group BG include a sense amplifier row 23, a column decoder 29 and a CL/BL control circuit 25. Furthermore, the DRAM 20 includes a clock generation circuit 30, a row address buffer 31, a column address buffer 32, a mode register 33, a command decoder 34, a chip control circuit 35, an input/output control circuit 36, and a data input/output buffer 37.

In FIG. 3, the address received from the DRAM controller 16 includes the memory bank group address, the bank address, and row and column addresses. Among these, the bank group address, the bank address and the row address are stored in the row address buffer 31 and are sent to the row decoder 21. If the memory system is configured using a plurality of DRAM chips and the bank groups BG are provided in different ones of the DRAM chips, as described above, the bank group address may be supplied as a chip select signal /CS. Further, the column address is stored in the column address buffer 32 and is sent to the column decoder 24. Under the control of the array control circuit 22, an access to a memory cell corresponding to a word line selected by the row decoder 21 and a bit line selected by the column decoder 24 is performed. The input/output control circuit 36 controls data transfer between the sense amplifier row 23 and the data input/output buffer 37, and data stored in the data input/output buffer 37 is transmitted from/to the DRAM controller 16 through DQ terminals. The input/output control circuit 36 may include a latch circuit including a FIFO capable of latching a maximum value of the burst length BL. The CL/BL control circuit 24 controls an operation suitable for the CAS latency CL and the burst length BL when the data transfer is made by the column circuits.

The clock generation circuit 30 receives complementary external clocks CK and /CK and a clock enable signal CKE from the DRAM controller 16, and generates internal clocks based on the clocks CK and /CK when the clock enable signal CKE is set to a high level. As shown in FIG. 3, the internal clocks outputted from the clock generation circuit 30 are supplied to various parts of the DRAM 20. The command decoder 34 determines a command from the DRAM controller 16 based on the chip select signal /CS and the control signals /RAS, /CAS and /WE. The command determined by the command decoder 34 is sent to the chip control circuit 35. The chip control circuit 35 controls operations of various parts of the DRAM 20 in response to the command received from the command decoder 34. The chip control circuit 35 controls the operation in conjunction with the internal clocks generated by the clock generation circuit 30.

The mode register 33 selectively sets operation modes of the DRAM 20 based on the above address when receiving a mode register setting command among the commands, and sends its setting data to the chip control circuit 35. The mode register 33 includes registers for storing the setting data. The registers of the mode register 33 include a CL/BL setting register (the second register) for setting the CAS latency CL and the burst length BL for each memory bank group BG, and the setting data stored in the CL/BL setting register are sent to the above CL/BL control circuit 25, which will be described in detail later.

FIG. 4 shows a configuration example of the memory bank groups BG in the DRAM 20 of FIG. 3. The DRAM chip Cl in which the DRAM 20 of FIG. 3 is implemented includes four memory bank groups BG (memory bank groups BG(0) to BG(3)) of the same size. Each memory bank group BG includes four memory banks of the same size. That is, the entire DRAM chip C1 includes sixteen memory banks (represented as memory banks 0 to F in hexadecimal) that are grouped into the four memory bank groups BG, in which memory banks 0 to 3 form the memory bank group BG(0), the memory banks 4 to 7 form the memory bank group BG(1), the memory banks 8 to B form the memory bank group BG(2), and the memory banks C to F form the memory bank group BG(3). Each of the sixteen memory banks 0 to F is provided with a plurality of memory cells formed at intersections of a plurality of word lines and a plurality of bit lines. Thereby, an arbitrary memory bank in an arbitrary memory bank group BG is selected by the bank group address and the bank address, and thus an arbitrary memory cell in the selected memory bank can be selected by the row and column addresses.

In addition, although the four memory bank groups BG are assigned to one DRAM chip C1 in the example of FIG. 4, different memory bank groups BG may be assigned to different DRAM chips C1, as described previously. In this case, in order to select any of memory bank groups BG assigned to the different DRAM chip C1, the chip select signal /CS that is unique to each DRAM chip C1 may be used instead of the memory bank group address. Further, one CL/BL setting register of the mode register 33 may be provided in each DRAM chip C1. When employing such a configuration, the system LSI 10 of FIG. 1 controls a predetermined number of DRAM chips C1 corresponding to a plurality of memory bank groups BG as one memory system (DRAM 20).

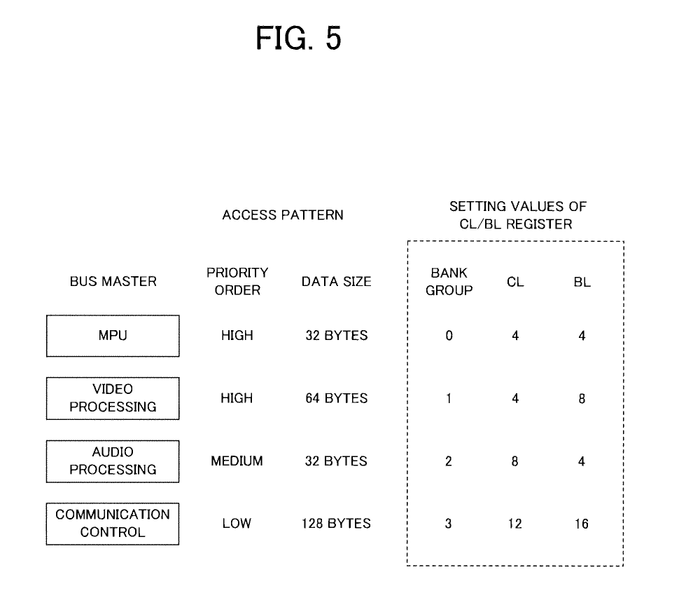

Next, a setting method for accessing the DRAM 20 from the bus master 11a will be described with reference to FIGS. 5 to 8. FIG. 5 shows a specific example of access patterns of the bus masters 11a and setting values of the CL/BL register 15a corresponding to the access patterns. Each access pattern shown in FIG. 5 includes a priority order and a data size of each of the four processing engines 11 (FIG. 1) when each of the processing engines 11 servers as a bus master 11a. Further, register set values corresponding to each access pattern include a memory bank group BG (numbers 0 to 3) to be accessed, and the CAS latency CL and the burst length BL that are set during the access. In FIG. 5, it is assumed that the DRAM 20 has a data bus width of 8 bytes, and thus each data size is a certain number times 8 bytes.

Specifically, when each of the MPU 11(1) , the video processing engine 11(2), the audio processing engine 11(3) and the communication control engine 11(4) serves as the bus master 11a, each of the memory bank groups BG(0), BG(1), BG(2) and BG(3) is assigned to the bus master ila in this sequence. Here, the priority order of access is set to “high” for the MPU 11(1) and the video processing engine 11(2), the priority order of access is set to “medium” for the audio processing engine 11(3), and the priority order of access is set to “low” for the communication control engine 11(4). Further, the CAS latency CL corresponding to the priority order of access is set to CL=4 for the MPU 11(1), CL=4 for the video processing engine 11(2) , CL=8 for the audio processing engine 11(3), and CL=12 for the communication control engine 11(4). In this manner, it is understood that the higher the priority order of access is, the lower the CAS latency CL is set.

Further, the data size of each access pattern is a size of data handled in one memory access. Specifically, the data size of the MPU 11(1) is set to 32 bytes, the data size of the video processing engine 11(2) is set to 64 bytes, the data size of the audio processing engine 11(3) is set to 32 bytes, and the data size of the communication control engine 11(4) is set to 128 bytes. Further, the burst length BL corresponding to the data size is set to BL=4 for the MPU 11(1) , BL=8 for the video processing engine 11(2) , BL=4 for the audio processing engine 11(3), and BL=16 for the communication control engine 11(4). Although FIG. 5 shows the example in which each data size is eight times the burst length BL, a relation between the data size and the burst length BL is not limited to this example.

In addition, a situation is assumed in which the bus master 11a, which mainly accesses the memory bank group BG to be accessed shown in FIG. 5, accesses another memory bank group BG. In this case, the bus master 11a uses the CAS latency CL and the burst length BL being set corresponding to the memory bank group BG to be accessed. However, if such access occurs frequently, there is a possibility of performance deterioration of the entire memory system LSI 10. Thus, in the embodiment, the four processing engines 11 transmit data between one another by using the on-chip memory 14 in the system LSI 10, and the above frequency of the access is reduced so that the performance deterioration of the system LSI 10 can be suppressed.

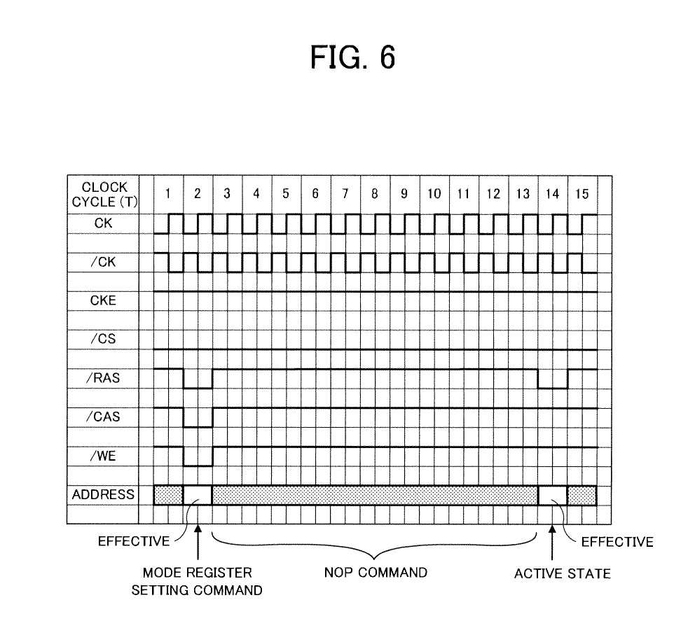

FIG. 6 shows a diagram explaining the setting method of the mode register 33 of the DRAM 20. A clock cycle T is shown in the uppermost part of FIG. 6, which is updated sequentially within a range of 1 to 16 in conjunction with a period of the clocks CK and /CK. Then, at a timing of T=2, all of the chip select signal /CS and the control signals /RAS, /CAS and /WE change to a low level when the clock enable signal CKE is maintained at a high level. Thereby, the command decoder 34 receives the mode register setting command. At this point, the address becomes effective at the timing of T=2, and the data is set into the mode register 33 in accordance with a state of the address field. Thereafter, at a timing of T=3, the chip select signal /CS changes to a low level and the respective control signals /RAS, /CAS and /WE change to a high level. Thereby, the decoder 34 receives a NOP command. Subsequently, the NOP command is maintained during a period from T=3 to T=13, and updating the value in the mode register 33 is completed during this period. Then, at a timing of T=14, the control signal /RAS changes to a low level, thereby shifting to an active state in which general commands can be inputted.

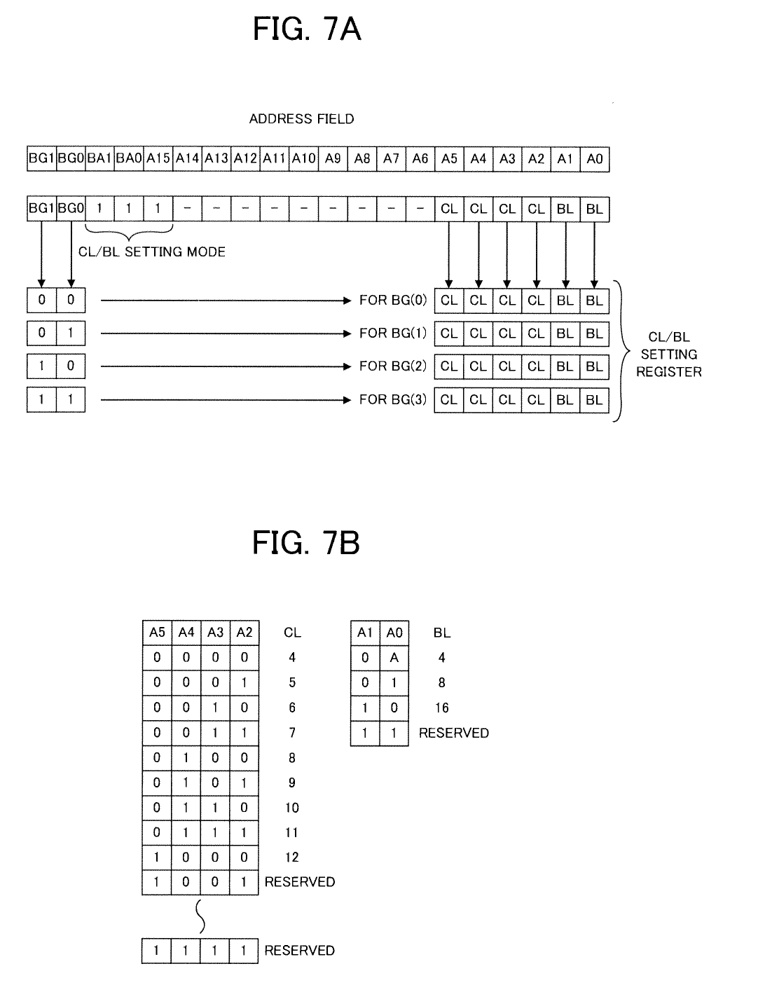

FIGS. 7A and 7B show a specific example of data structure of the address field and set values in the CL/BL setting register in case of setting the CAS latency CL and the burst length BL in the mode register 33. The address field is composed of 20 bits in total, which includes two bits BG1 and BG0 for designating the memory bank group BG, two bits BA1 and BA0 for designating the memory bank in the memory bank group BG, and bits A15 to A0 for designating the address in the memory bank, as shown in FIG. 7A. The address field for which the mode register setting command of FIG. 6 is received is determined as CL/BL setting mode, for example, when all of three bits BA1, BA0 and A15 are 1. In this case, the value of lower six bits A5 to A0 of the address field is set in the CL/BL setting register corresponding to the memory bank group BG that is designated by the value of the two bits BG1 and BG0. Specifically, the value of four bits A5 to A2 is set as the CAS latency CL in the CL/BL setting register, and the value of two bits A1 and A0 is set as the burst length EL in the CL/BL setting register.

FIG. 7B shows a relation between the bits A5 to A2 of the address field and register values of the CAS latency CL, and a relation between the bits A1 and A0 of the address field and register values of the burst length BL. In the example of FIG. 7B, register values within a range of CAS latencies CL of 4 to 12 are assigned to nine patterns among sixteen patterns of the bits A5 to A2, and register values within a range of burst lengths BL of 4, 8 and 16 are assigned to three patterns among four patterns of the bits A1 and A0. Other patterns of the address field are not used (reserved bits). In addition, when setting values of four CL/BL setting registers corresponding to four memory bank groups BL, a setting cycle of the mode register 33 may be repeated four times, with the upper two bits BG1 and BG0 of the address field being changed.

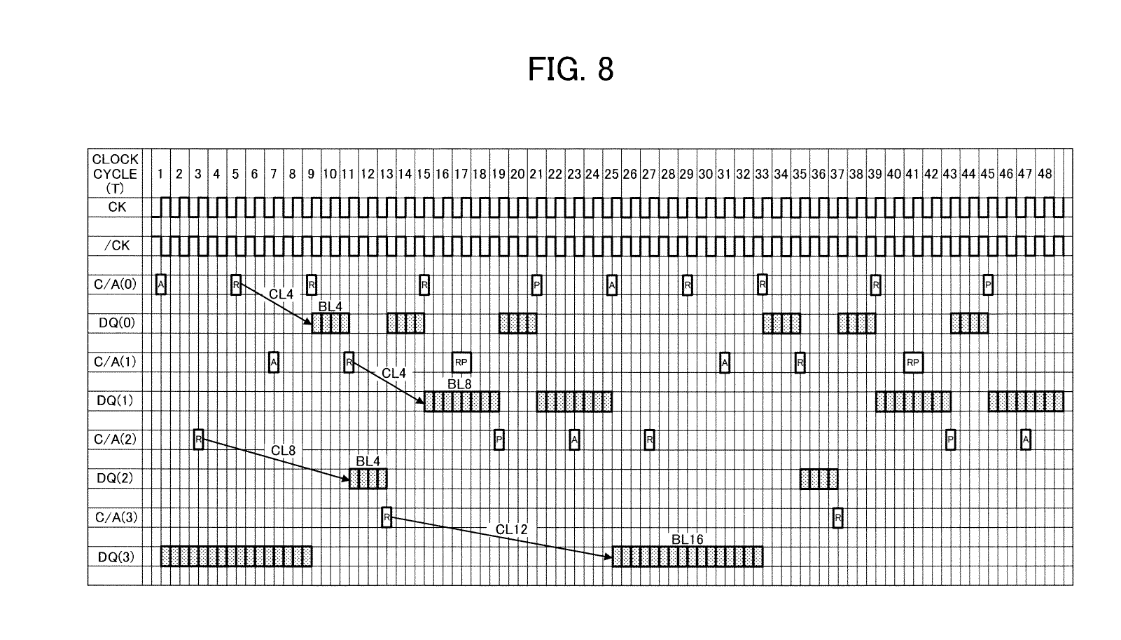

FIG. 8 shows a specific example of the access pattern when the DRAM is accessed by the LSI 10. The meanings of the clock cycle T and the clocks CK and /CK shown at the left end of FIG. 8 are the same as those in FIG. 6. Each of four inputs C/A(i) shown at the left end in relation to i=0, 1, 2 and 3 means command and address inputs for a memory bank group BG(i). Similarly, each of four inputs/outputs DQ(i) shown at the left end in relation to i=0, 1, 2 and 3 means data input/output for the memory bank group BG(i). Commands issued from the external memory controller 13 at predetermined timings are shown for the respective inputs C/A(i). The commands specifically include a bank active command A to activate a memory bank to be accessed, a read command R to read data, a read precharge command RP to automatically precharge a bit line after reading data, and a precharge command P to precharge a memory bank. Each of these commands is performed according to a simultaneously received address.

In FIG. 8, since a command bus, an address bus and a data bus are shared by all the memory bank groups BG, two or more commands, addresses or data are controlled so that their timings do not overlap with one another. Further, in the example of FIG. 8, a minimum input interval between the commands and the addresses corresponds to four periods of the clock cycle T for the same memory bank group BG, and corresponds to two periods of the clock cycle T for different memory bank groups BG.

In FIG. 8, when focusing attention on, for example, the memory bank group BG(0) that is accessed by the MPU 11(1), one page (data corresponding to one word line) of a memory bank whose address is designated by the bank active command A issued at the timing of T=1 is activated. Thereafter, a read command R is issued at a timing of T=5, which instructs reading of data starting from a designated address in the active page. At this point, the memory bank group BG(0) is set to CL=4 and BL=4, as shown in FIG. 5, and therefore a burst read operation with the burst length BL of 4 bits is started at a timing of T=9 at which four periods has passed from T=5. In addition, since the DRAM 20 of DDR type is assumed in the embodiment, as described above, 2-bit data is inputted/outputted in a burst mode within one period of the clock cycle T. Subsequently, a series of commands including the read command R, the precharge command P, the bank active command A and the like are performed at predetermined timings of the clock cycle T.

Further, the commands are sequentially performed according to the above process for the other memory bank groups BG(1) to BG(3). Here, when focusing attention on, for example, the memory bank group BG(2) that is accessed by the audio processing engine 11(3), the priority order of access is set to “medium” which is lower than that of the MPU 11(1), and the CAS latency CL is set to CL=8 which is twice that of the MPU 11(1), as shown in FIG. 5. Therefore, after the read command R is issued at the timing T=3, it is understood that reading of the memory bank group BG(0) corresponding to the read command R is performed first and thereafter reading of the memory bank group BG(2) is performed. That is, the control of the embodiment can perform an operation of a memory bank group BG whose priority order of access is relatively high ahead of other operations regardless of the issue timings of commands, and therefore it is possible to obtain an effect of improving efficiency of data processing of the processing engines 11. Further, since the burst length BL can be set for each memory bank group BG under the control of the embodiment, it is possible to drastically reduce the frequency of sending the commands and addresses in comparison with a case of accessing all the memory bank groups BG with the same burst length BL (for example, BL=4). Thereby, even when the commands/addresses are sent frequently, it is possible to effectively perform pipeline control in a plurality of memory bank groups BG.

Although the read operation for the DRAM 20 is assumed in the description of the embodiments, the present invention can be applied to a write operation for the DRAM 20. In the write operation of this case, the values of the CAS latencies CL set in the CL/BL register 15a of the access controller 15 of FIG. 2 can be used, and instead, another register for setting CAS write latencies CWL for each memory bank group BG may be separately provided. Based on a received write request from a processing engine 11 serving as the bus master 11a, a write command is issued to the DRAM 20 and data can be written into a predetermined memory bank in a corresponding memory bank group BG.

As described above, the embodiments of the invention have been described. However the invention is not limited to the above embodiments and can variously be modified without departing the essentials of the invention. For example, although the DRAM 20 configured using volatile memory cells has been shown as the memory system of the embodiments, the invention can be also applied to a memory system configured using non-volatile memory cells, or a memory system configured using both the volatile and non-volatile memory cells. In this case, the volatile and non-volatile memory cells can be flexibly selected for each of a plurality of memory bank groups BG corresponding to a plurality of processing engines 11. For example, it is possible to employ a configuration in which a first memory bank group configured using volatile memory cells is implemented in a first memory chip, a second memory bank group configured using non-volatile memory cells is implemented in a second memory chip, and the first and second memory chips and the control system are connected to one another by TSVs.

Further, engines of various applications can be used as the processing engines 11 shown in the embodiments, without being limited to the above examples. For example, various devices such as CPU (Central Processing Unit), MCU (Micro Control Unit), DSP (Digital Signal Processor), ASIC (Application Specific Integrated Circuit) and ASSP (Application Specific Standard Product) can be used as the processing engines 11. Further, the invention can be applied to various device structures such as SOC (System on Chip), MCP (Multi Chip Package) and POP (Package on Package). Among these, in the MCP, a structure maybe employed in which a chip functioning as a control system and a memory chip having a memory region are connected to each other by TSVs. Further, in the MCP, a structure may be employed in which a chip including a plurality of processing engines 11 and a chip functioning as a control system are connected to each other by TSVs. Furthermore, in the SOC, a plurality of processing engines 11 and a control chip may be implemented on a single chip. The invention can be widely applied to systems including various devices and packages as described above.

Further, field-effect transistors (FETs) can be used as transistors included in the data processing system of the invention, and various FETs such as not only MOS (Metal Oxide Semiconductor) transistors but also MIS (Metal-Insulator Semiconductor) transistors may be used. Further, the system may partially include bipolar transistors.

The present invention can be applied to devices based on various combinations or selections of the disclosure of the embodiments. That is, the present invention covers various modifications which those skilled in the art can carry out in accordance with all disclosures including claims and technical ideas.

1. A device comprising:
a register storing a plurality of latency data that correspond to a plurality of access request sources, respectively, each of the latency data including a period of time between issue of a data transfer request command responsive to an access request from an associated one of the access request sources and initiation of a data transfer operation responsive to the data transfer request command; and
a control unit configured to respond to the latency data stored in the register and control an order in issue of data transfer request commands responsive respectively to access requests from the access request sources so that between issue of a first data transfer request command responsive to a first access request from a first one of the access request sources and initiation of a first data transfer operation responsive to the first data transfer request command, at least issue of a second data transfer request command responsive to a second access request from a second one of the access request sources is performed.

2. The device as claimed in claim 1, wherein a second data transfer operation responsive to the second data transfer request command is further performed between the issue of the first data transfer request command and the initiation of the first data transfer operation responsive to the first data transfer request command.

3. The device as claimed in claim 1, wherein each of the data transfer request commands including the first and second data transfer request commands includes at least one of a data write request command and a data read request command.

4. The device as claimed in claim 1, further comprising a memory unit coupled to the control unit, each of the first and second data transfer request commands including a data write request command and a data read request command, and each of the first and second data transfer operations including writing data into the memory unit from the control unit when the data write request command is issued and reading data from the memory unit to the control unit when the data read request command is issued.

5. The device as claimed in claim 4, wherein the data to be written into the memory unit includes a plurality of bits that are outputted from the control unit successively, and the data to be read out from the memory unit includes a plurality of bits that are supplied to the control unit successively.

6. The device as claimed in claim 2, further comprising a command terminal and a data terminal that are to be coupled to an external unit, the second data transfer request command is supplied to the external unit from the control unit through the command terminal after the first data transfer request command is supplied to the external unit from the control unit through the command terminal, and the second data transfer operation is performed through the data terminal between the control unit and the external unit before the first data operation is performed through the data terminal between the control unit and the external unit.

7. The device as claimed in claim 6, wherein the external unit comprises a memory unit including a plurality of memory bank groups that are allocated to the access request sources, respectively.

8. The device as claimed in claim 7, wherein the first data transfer operation is performed on a first one of the memory banks allocated to the first one of the access request sources and the second data transfer operation is performed on a second one of the memory banks allocated to the second one of the access request sources.

9. A data processing system comprising:
a memory system comprising a plurality of memory bank groups each including a plurality of memory banks storing data;
a control system comprising a plurality of processing engines processing the data and a memory controller controlling an access to the memory system from the processing engines, the plurality of processing engines corresponding to the plurality of memory bank groups to be accessed;
data lines transmitting the data between the memory system and the memory controller; and
a first register storing access data including a plurality of latencies each as a time interval from issuing a command for each of the memory bank groups to staring a data transfer through the data lines, the first register being included in the memory controller,
wherein each of values of the plurality of latencies is corresponded to a priority order of an access of each of the processing engines,
and the memory controller controls an order of issuing commands for at least two of the memory bank groups in response to access requests from the processing engines based on the access data including the plurality of latencies.

10. The system as claimed in claim 9, wherein the access data further includes burst lengths each indicating how many times a plurality of bits of data are transferred sequentially in each access unit, the burst lengths corresponding to the plurality of memory bank groups respectively.

11. The system as claimed in claim 9, wherein the higher the priority order of each of the processing engines is, the smaller each of the values of the latencies is set.

12. The system as claimed in claim 9, wherein the data lines transmit the data of each of the memory bank groups.

13. The system as claimed in claim 9,
wherein the memory system further comprises:
a second register storing access data including the plurality of latencies; and
a control circuit controlling an access to each of the memory bank groups to be accessed based on corresponding one of the latencies stored in the second register.

14. The system as claimed in claim 13, wherein the memory controller issues a set command to set access data being same as the access data stored in the first register into the second register.

15. The system as claimed in claim 9, wherein the memory controller arbitrates access requests from the processing engines, sends access permission to one of the processing engines serving as a bus master, and gives an exclusive right to use a bus to the bus master so as to transfer data from the bus master through the memory controller to the memory system.

16. The system as claimed in claim 15, wherein the command is a read command to read data from the memory system.

17. The system as claimed in claim 15, wherein the command is a write command to write data into the memory system.

18. The system as claimed in claim 16, wherein before issuing the command, the memory controller issues a bank active command to activate one of the memory banks to be accessed.

19. The system as claimed in claim 9, wherein at least one of the processing engines and the memory controller are implemented in a single chip.

20. The system as claimed in claim 9, wherein the memory system is configured with one or more chips.
